(19) United States
(12) Patent Application Publication
(10) Pub. No.: US 2017/0116360 A1
(43) Pub. Date: Apr. 27, 2017

(54) Efficient explicit finite element analysis of a product with a time step size control scheme

(71) Applicant: Livermore Software Technology Corporation, Livermore, CA (US)

(72) Inventor: Zhidong Han, San Ramon, CA (US)

(21) Appl. No.: 14/924,274

(22) Filed: Oct. 27, 2015

(51) Int. Cl. G06F 17/50

(52) U.S. Cl. CPC G06F 17/5018

(57) ABSTRACT

FEA model contains first and second layers of nodes to form a group of node-pairs, each containing one node in the first layer and a corresponding node in the second layer. Nodes in each node-pair are located in a substantially closer distance comparing with distances to other nodes. Candidate finite elements for controlling time-step size are identified. Each candidate finite element is defined by one or more node-pairs. At each solution cycle of a time-marching simulation, nodal forces of the FEA model including candidate finite elements are obtained. A scaled dimension is calculated by multiplying the smallest dimension with a speed-up scale factor. A critical dimension for controlling the next solution cycle's time-step size is then determined. A fraction of the corresponding nodal forces to be redistributed for maintaining a stable solution are calculated and redistributed according to a formula based nodal masses and speed-up scale factor.

### FIELD

The present invention generally relates to computer-aided engineering analysis, more particularly to methods and systems for numerically simulating structural behaviors of a product (e.g., automobile, airplane, etc.) using explicit finite element analysis (FEA) with a time-step size control scheme.

### BACKGROUND

Finite element analysis (FEA) is a computerized method widely used in industry to model and solve engineering problems relating to complex systems such as three-dimensional non-linear structural design and analysis. FEA derives its name from the manner in which the geometry of the object under consideration is specified. With the advent of the modern digital computer, FEA has been implemented as FEA software. Basically, the FEA software is provided with a model of the geometric description and the associated material properties at each point within the model. In this model, the geometry of the system under analysis is represented by solids, shells, beams and other structural components of various sizes, which are called elements. The vertices of the elements are referred to as nodes. The model is comprised of a finite number of elements, which are assigned a material name to associate the elements with the material properties. The model thus represents the physical space occupied by the object under analysis along with its immediate surroundings. The FEA software then refers to a table in which the properties (e.g., stress-strain constitutive equation, Young's modulus, Poisson's ratio, thermo-conductivity) of each material type are tabulated. Additionally, the conditions at the boundary of the object (i.e., loadings, physical constraints, etc.) are specified. In this fashion a model of the object and its environment is created.

FEA has two solution techniques: the implicit finite element analysis (“the implicit method”) and the explicit finite element analysis (“the explicit method”). Both methods are used to solve transient dynamic equations of motion and thus obtain an equilibrium solution to the equations. The methods march from time (t) through a discrete time interval or time-step size Δt, to time (t+Δt). The time step-size Δt is determined (i.e., calculated) at each solution cycle for the next solution cycle. Such methods are sometimes referred to as time-marching simulation, which contains a number of consecutive time steps or solution cycles.

The present invention relates to the explicit method, which is stable only if time-step size is very small—specifically, the time-step size must be smaller than the time taken for an elastic wave to propagate from one side of an element to the other. The maximum time-step size for maintaining a stable solution in the explicit method is referred to as the critical time-step size Δt_{cr}. The speed of the elastic wave is a function of material mass and stiffness of the structure represented by the finite element and the element's size or dimension. For a FEA model having substantially similar material, the smallest element generally controls the critical time-step size.

Even one substantially smaller element in a FEA model can cause the critical time-step size unnecessarily small for majority of the elements in the FEA model. As a result, a very small time step would be required for the remaining of the numerical simulation. Not only would the simulation become very real time consuming, but also impractical. For example, it takes too long to obtain a simulated result for engineer to make design decision in time to meet the commercial need.

This problem becomes worse when thick-shell finite elements or a single layer of solid/structural finite element having one substantially smaller dimension are used. The thickness of the thick-shell finite element would control the time-step size, which causes the time-marching numerical simulation to consume too much computer resources thereby impractical for real-world production.

It would therefore be desirable to have a time-step size control scheme to ensure efficient explicit FEA for obtaining simulated structural behaviors of a product.

### SUMMARY

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

Systems and methods of numerically simulating structural behaviors of a product using an explicit FEA with a time-step size control scheme are disclosed. According to an exemplary embodiment, a finite element analysis (FEA) model representing a product is defined and received in a computer system having an explicit FEA application module installed thereon. The FEA model contains at least first and second layers of corresponding nodes to form a group of node-pairs. Each node-pair contains one node in the first layer and a corresponding node in the second layer. The nodes in each node-pair are located in a substantially closer distance to each other comparing with distances to other nodes in the FEA model. A group of candidate finite elements for controlling time-step size is identified. Each candidate finite element is defined by one or more node-pairs.

Simulated structural behaviors of the product are then obtained by conducting a time-marching numerical simulation using the FEA model in a number of solution cycles. At each solution cycle, nodal forces of the FEA model including all candidate finite elements are obtained in accordance with the explicit FEA scheme. A scaled dimension is calculated by multiplying the smallest dimension of the candidate finite elements with a speed-up scale factor (e.g., greater than 1). The scaled dimension is then compared with other dimensions to determine a critical dimension for controlling the next solution cycle's time-step size. A fraction of the corresponding nodal forces to be redistributed for maintaining a stable solution are calculated and redistributed in accordance with a formula based on nodal masses, nodal forces and the speed-up scale factor.

A new time-step size for the next solution cycle is then calculated using the critical dimension (i.e., may or may not be the scaled dimension). The simulation time is then incremented by the calculated new time-step size to repeat aforementioned actions in a new solution cycle until an end condition for the time-marching numerical simulation has reached.

Objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIGS. 1A-1B collectively show a flowchart illustrating an example process of numerically simulating structural behaviors of a product using explicit finite element analysis (FEA) with a time-step size control scheme, according to an embodiment of the present invention;

FIG. 2 is a diagram graphically showing example first and second layers of nodes according to one embodiment of the present invention;

FIG. 3A is a diagram showing example thick-shell finite elements or solid finite elements in a single layer according to one embodiment of the present invention;

FIG. 3B is a diagram showing example beam/truss finite elements according to one embodiment of the present invention;

FIG. 4A is a diagram showing example node-pair's substantially closer distance compared with other distances to other nodes in accordance with one embodiment of the present invention;

FIG. 4B is a diagram showing example comparison to determine the critical dimension for time-step size calculation after applying the speed-up scale factor in accordance with one embodiment of the present invention;

FIG. 5 is a diagram showing an example of nodal force redistributions in a time-step size control scheme according to an embodiment of the present invention;

FIG. 6 is a function diagram showing salient components of an exemplary computer, in which one embodiment of the present invention may be implemented.

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, and components have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

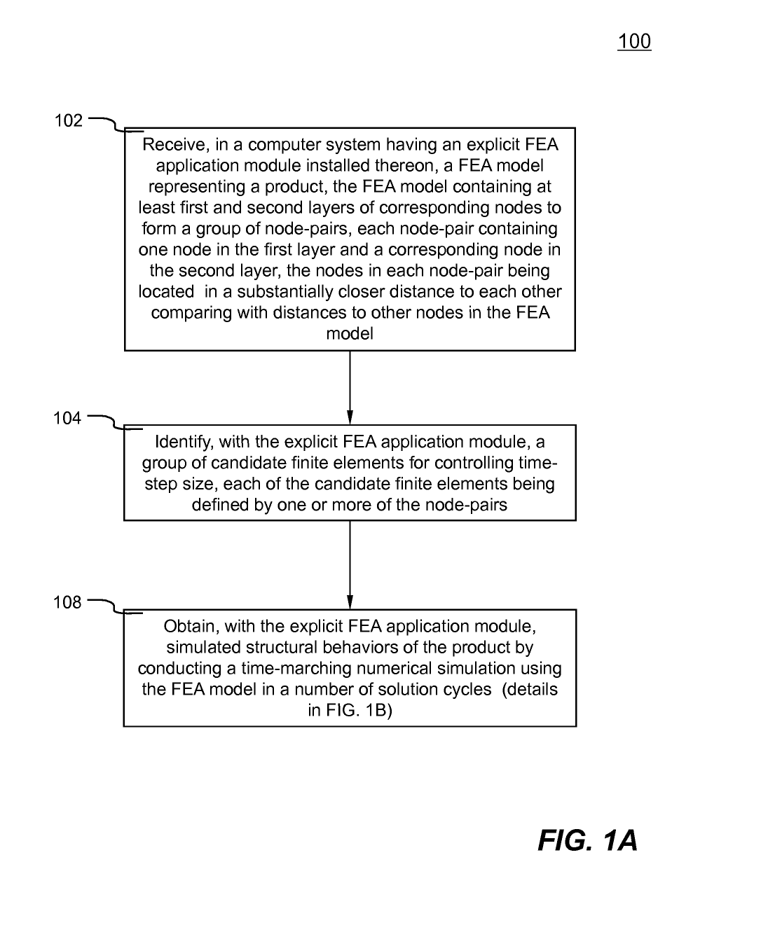

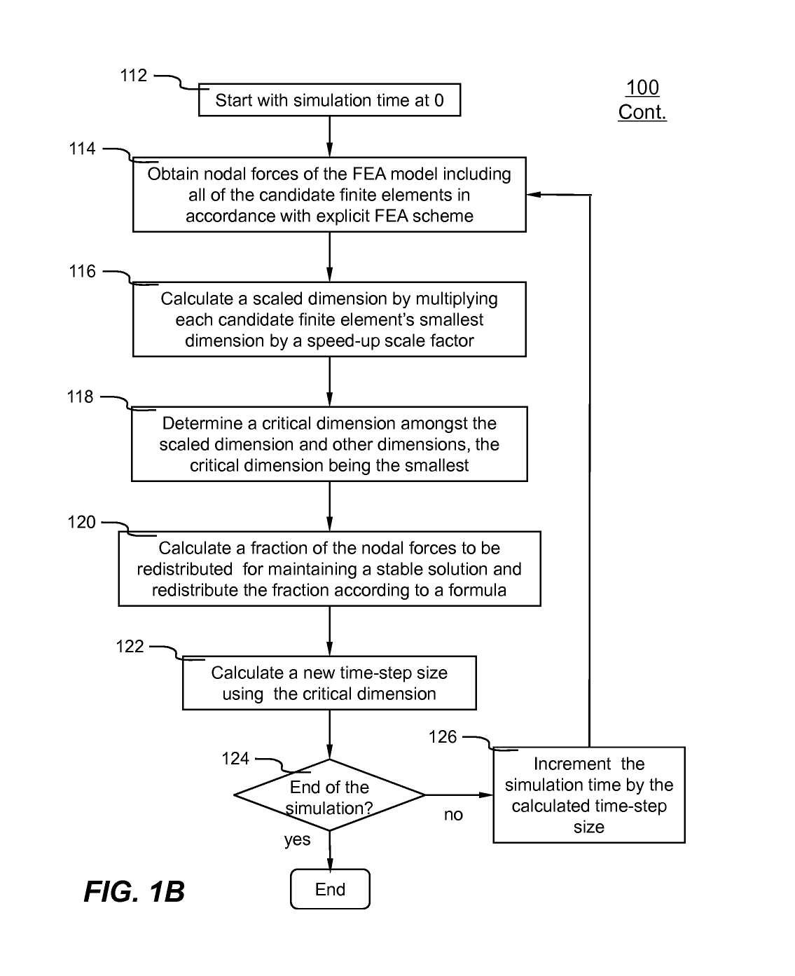

Embodiments of the present invention are discussed herein with reference to FIGS. 1A-6. However, those skilled in the art will readily appreciate that the detailed description given herein with respect to these figures is for explanatory purposes as the invention extends beyond these limited embodiments.

FIGS. 1A-1B collectively show a flowchart illustrating an example process 100 of numerically simulating structural behaviors of a product using explicit finite element analysis (FEA) with a time-step size control scheme, according to an embodiment of the present invention. Process 100 is preferably understood in conjunction with other figures and is implemented in software.

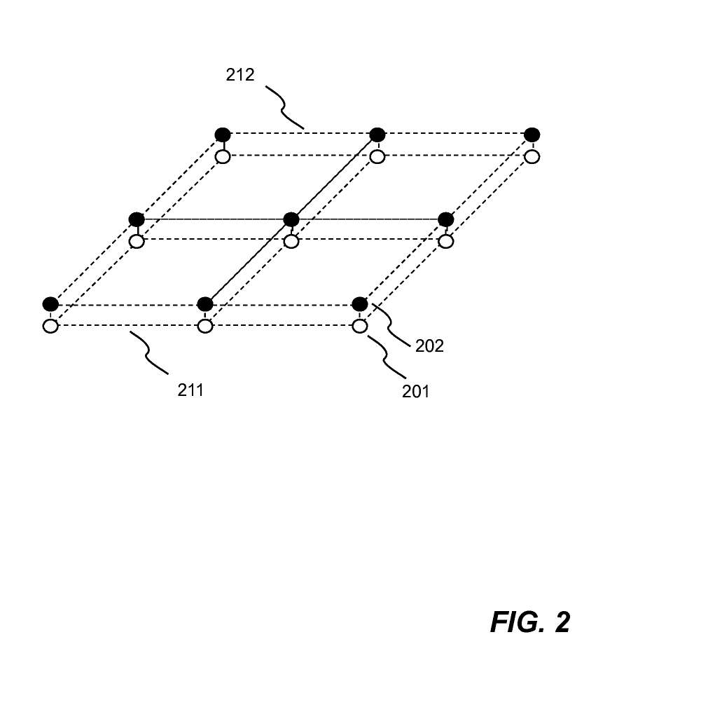

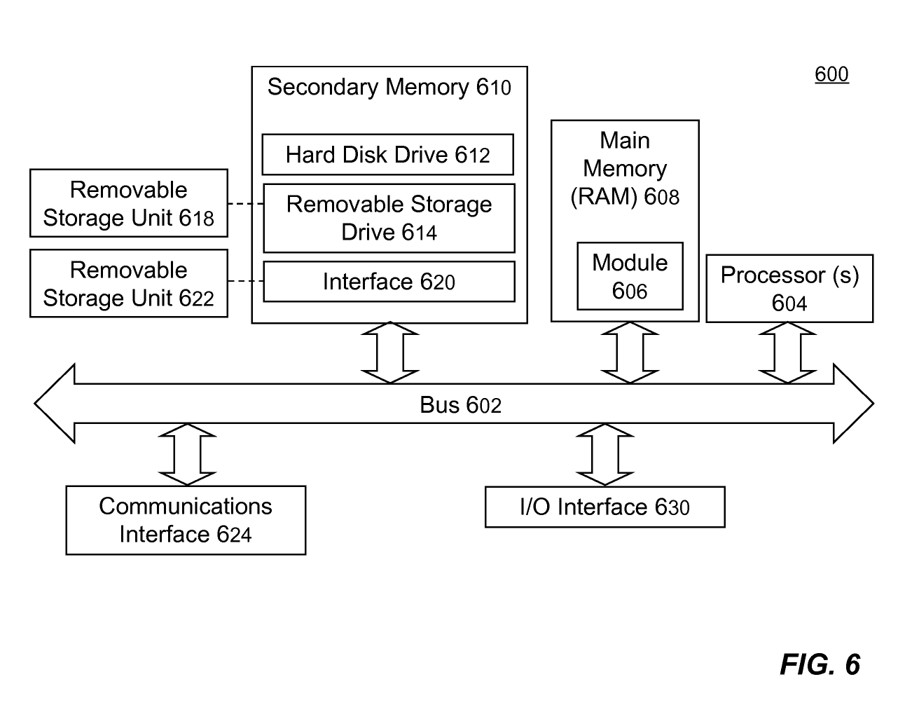

Process 100 starts by receiving a finite element analysis (FEA) model, which represents a product or structure (e.g., an automobile, an airplane, a panel of a car, etc.) in a computer system (e.g., computer system 600 of FIG. 6) at action 102. The FEA model containing a plurality of nodes including at least first and second layers of corresponding nodes to form a group of node-pairs. Each node-pair contains one node in the first layer and a corresponding node in the second layer. The nodes in each node-pair are located in a substantially closer distance compared with distances to other nodes in the FEA model. In one example, the substantially closer distance is 5-10 times smaller than other distances. FIG. 2 shows two example layers of nodes that can be used in a FEA model according to an embodiment of the present invention. The first layer 211 of nodes (shown as hollow circles) and the second layer 212 of nodes (shown as solid circles) contain corresponding nodes to form node-pairs. Each node-pair contains two nodes, for example node N1 201 (hollow circle) and N2 202 (solid circle).

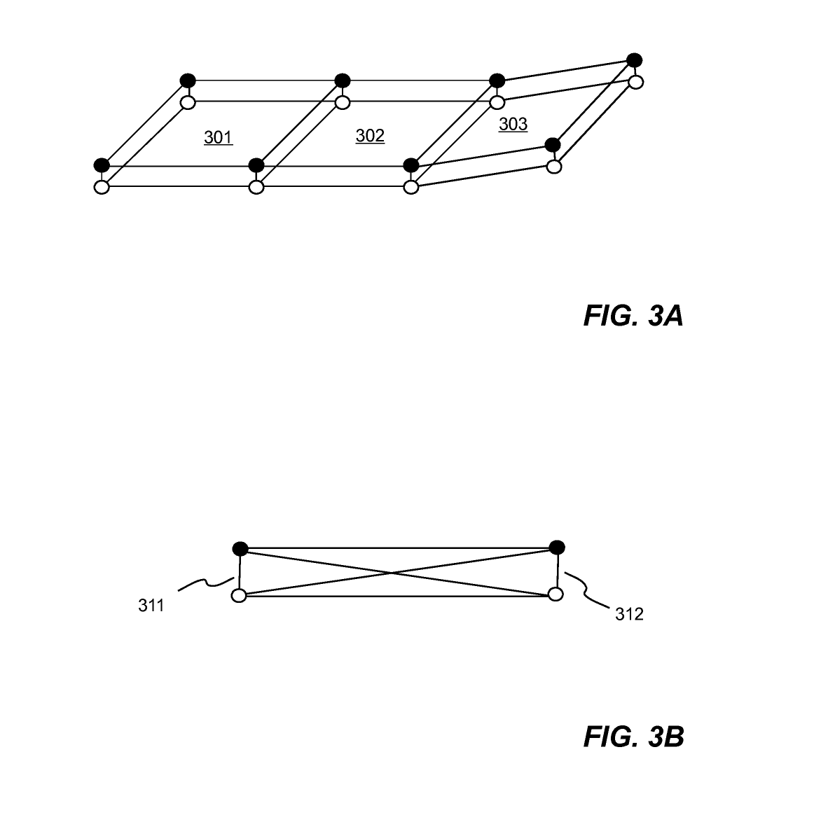

Next, at action 104, a group of candidate finite elements are identified for controlling time-step size (i.e., the smallest dimension for calculating the time-step size for next solution cycle). The candidate finite elements are defined by one or more node-pairs. FIG. 3A shows three example thick-shell finite elements or solid finite elements 301-303 in a single layer according to one embodiment of the present invention. Each thick-shell or solid finite element is defined by four node-pairs. FIG. 3B shows a couple of beam/truss finite elements 311-312, each defined by one node-pair, according to an embodiment of the present invention.

There are a number of techniques to identify such a group. For example, user can specify one or more groups in the input to the FEA. It may also be done with an automated procedure by checking the initial size and/or topology of each finite element to determine.

Next, at action 108, simulated structural behaviors of the product are obtained by conducting a time-marching numerical simulation using the FEA model with the explicit FEA application module.

The time-marching simulation contains a number of solution cycles or time steps and starts by setting the simulation time to zero at action 112.

At action 114, nodal forces for the FEA model including all candidate finite elements are obtained via explicit FEA scheme. A scaled dimension of each candidate finite element is calculated by multiplying the smallest dimension by a speed-up scale factor (e.g., a factor greater than 1) at action 116. Generally, the smallest dimension is the substantially closer distance between each node-pair.

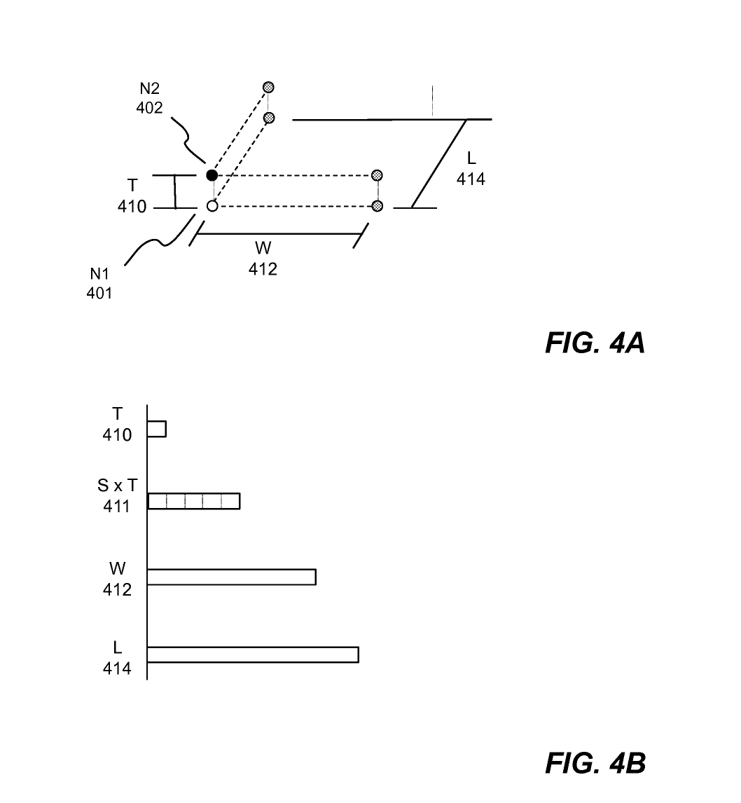

The scaled dimension is compared to other dimensions (e.g., length and width of the thick-shell finite element or solid finite element) to determine a critical dimension (i.e., the smallest dimension) for controlling the next solution cycle's time-step size at action 118. FIG. 4B is a diagram showing an example of such comparison. A scaled dimension (S×T) 411 equaling thickness T (i.e. T 410) multiplied by a speed-up scale factor S is compared with other dimensions of a candidate finite element (i.e., width W 412 and length L 414). In this example, the scaled dimension is still a critical dimension because it is the smallest dimension amongst all dimensions.

Additionally, FIG. 4A is a diagram showing a node-pair formed by node N1 401 and node N2 402 in accordance with one embodiment of the present invention. W 412 and L 414 are distances to other nodes in the FEA model, while T 410 is the substantially closer distance between the nodes 401-402 in the node-pair (N1-N2).

A fraction of the nodal forces (ΔF) for each node-pair of the candidate finite element (e.g., node pair N1-N2) is calculated in accordance with the following formula based on the speed-up scale factor, nodal forces and nodal masses. The fraction of the nodal forces is redistributed between nodes in each node-pair to ensure a stable solution can be achieved in the next solution cycle. It is noted that the next solution cycle is incremented by a larger time-step size due to the scaled dimension, when scaled dimension is a critical dimension.

$$α = \frac{{S}^{2}}{1 + {S}^{2}}$$

$${β}_{1} = α \frac{{m}_{2}}{{m}_{1} + {m}_{2}}$$

$${β}_{2} = α \frac{{m}_{1}}{{m}_{1} + {m}_{2}}$$

$$Δ F = {β}_{1} {F}_{1} - {β}_{2} {F}_{2}$$

$${F}_{1}^{final} = {F}_{1} - Δ F$$

$${F}_{2}^{final} = {F}_{2} + Δ F$$

where S is the speed-up scale factor, m₁ and m₂ are respective nodal masses of said each node-pair, F₁ and F₂ are the respective nodal forces of said each node-pair, ΔF is the calculated fraction of the corresponding nodal forces, and F₁^{final} and F₂^{final} are the respective nodal forces of said each node-pair after redistribution.

In many instances, the explicit FEA scheme requires the inverse of nodal masses be used for computations. When the inverse of nodal masses are stored in the computer system, two coefficients can be computed from the inverse quantities as follows:

$${β}_{1} = α \frac{1 / {m}_{1}}{1 / {m}_{1} + 1 / {m}_{2}}$$

$${β}_{2} = α \frac{1 / {m}_{2}}{1 / {m}_{1} + 1 / {m}_{2}}$$

Consolidating the intermediate steps, the fraction of the corresponding nodal forces can be written as follows:

$$Δ F = ( \frac{{S}^{2}}{1 + {S}^{2}} ) ( \frac{{F}_{1} / {m}_{1} - {F}_{2} / {m}_{2}}{1 / {m}_{1} + 1 / {m}_{2}} )$$

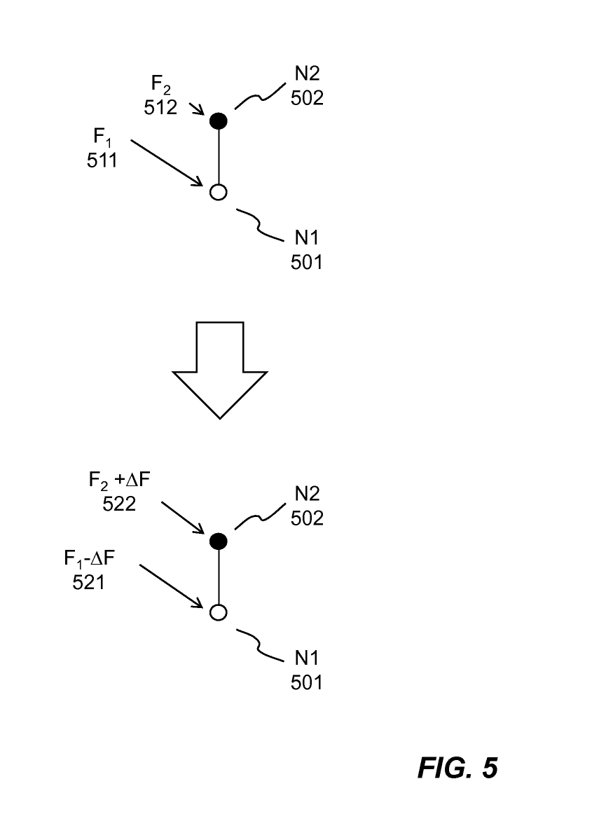

An example nodal force redistribution scheme is shown in FIG. 5. Nodal force F₁ 511 and nodal force F₂ 512 are obtained via explicit FEA for node N1 511 and node N2 512, respectively. After nodal force redistribution, respective nodal forces become F₁^{final}=F₁−ΔF 521 and F₂^{final}=F₂+ΔF 522.

Next, at action 122, a new critical time-step size is calculated using the critical dimension. Should the scaled dimension be the smallest, the time-step size would be scaled up by the speed-up scale factor. For example, when the speed-up scale factor of five is used, the time-step size will be five time larger than that of the normal explicit FEA scheme. To compensate the larger and supposedly unstable time-step size, nodal forces in the node-pairs of the candidate finite elements are redistributed accordingly.

Next, at decision 124, it is determined whether the time-marching numerical simulation has reached an end condition. If not, the simulation time is incremented by the calculated time-step size at action 126. Process 100 repeats actions 114-124 until the end condition is reached. The end condition can be a total simulation time specified by a user.

According to one aspect, the present invention is directed towards one or more computer systems capable of carrying out the functionality described herein. An example of a computer system 600 is shown in FIG. 6. The computer system 600 includes one or more processors, such as processor 604. The processor 604 is connected to a computer system internal communication bus 602. Various software embodiments are described in terms of this exemplary computer system. After reading this description, it will become apparent to a person skilled in the relevant art(s) how to implement the invention using other computer systems and/or computer architectures.

Computer system 600 also includes a main memory 608, preferably random access memory (RAM), and may also include a secondary memory 610. The secondary memory 610 may include, for example, one or more hard disk drives 612 and/or one or more removable storage drives 614, representing a floppy disk drive, a magnetic tape drive, an optical disk drive, etc. The removable storage drive 614 reads from and/or writes to a removable storage unit 618 in a well-known manner. Removable storage unit 618, represents a floppy disk, magnetic tape, optical disk, etc. which is read by and written to by removable storage drive 614. As will be appreciated, the removable storage unit 618 includes a computer usable storage medium having stored therein computer software and/or data.

In alternative embodiments, secondary memory 610 may include other similar means for allowing computer programs or other instructions to be loaded into computer system 600. Such means may include, for example, a removable storage unit 622 and an interface 620. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 622 and interfaces 620 which allow software and data to be transferred from the removable storage unit 622 to computer system 600. In general, Computer system 600 is controlled and coordinated by operating system (OS) software, which performs tasks such as process scheduling, memory management, networking and I/O services.

There may also be a communications interface 624 connecting to the bus 602. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. The computer 600 communicates with other computing devices over a data network based on a special set of rules (i.e., a protocol). One of the common protocols is TCP/IP (Transmission Control Protocol/Internet Protocol) commonly used in the Internet. In general, the communication interface 624 manages the assembling of a data file into smaller packets that are transmitted over the data network or reassembles received packets into the original data file. In addition, the communication interface 624 handles the address part of each packet so that it gets to the right destination or intercepts packets destined for the computer 600. In this document, the terms “computer program medium” and “computer usable medium” are used to generally refer to media such as removable storage drive 614, and/or a hard disk installed in hard disk drive 612. These computer program products are means for providing software to computer system 600. The invention is directed to such computer program products.

The computer system 600 may also include an input/output (I/O) interface 630, which provides the computer system 600 to access monitor, keyboard, mouse, printer, scanner, plotter, and alike.

Computer programs (also called computer control logic) are stored as application modules 606 in main memory 608 and/or secondary memory 610. Computer programs may also be received via communications interface 624. Such computer programs, when executed, enable the computer system 600 to perform the features of the present invention as discussed herein. In particular, the computer programs, when executed, enable the processor 604 to perform features of the present invention. Accordingly, such computer programs represent controllers of the computer system 600.

In an embodiment where the invention is implemented using software, the software may be stored in a computer program product and loaded into computer system 600 using removable storage drive 614, hard drive 612, or communications interface 624. The application module 606, when executed by the processor 604, causes the processor 604 to perform the functions of the invention as described herein.

The main memory 608 may be loaded with one or more application modules 606 that can be executed by one or more processors 604 with or without a user input through the I/O interface 630 to achieve desired tasks. In operation, when at least one processor 604 executes one of the application modules 606, the results are computed and stored in the secondary memory 610 (i.e., hard disk drive 612). The status of the finite element analysis is reported to the user via the I/O interface 630 either in a text or in a graphical representation.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. Whereas the speed-up scale factor has been shown and described as five (5) in FIG. 4B, other factors (greater than 1) can be used to achieved the same. Additionally, whereas first and second layers of nodes have been shown as flat layer in FIG. 2, other layer shapes can be used to achieve the same. In summary, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A method of obtaining simulated structural behaviors of a product using explicit finite element analysis (FEA) with a time-step size control scheme, the method comprising:
receiving, in a computer system having an explicit FEA application module installed thereon, a FEA model representing a product, the FEA model containing at least first and second layers of corresponding nodes to form a group of node-pairs, each node-pair containing one node in the first layer and a corresponding one in the second layer, the nodes in each node-pair being located in a substantially closer distance to each other comparing with distances to other nodes in the FEA model;
identifying, with the explicit FEA application module, a group of candidate finite elements for controlling time-step size, each of the candidate finite elements being defined by one or more of the node-pairs; and
obtaining, with the explicit FEA application module, simulated structural behaviors of the product by conducting a time-marching numerical simulation using the FEA model in a number of solution cycles as follows:
(a) setting a simulation time to zero;
(b) obtaining nodal forces of the FEA model including all of the candidate finite elements at the simulation time;
(c) calculating a scaled dimension by multiplying said each candidate finite element's smallest dimension by a speed-up scale factor;
(d) determining a critical dimension amongst the scaled dimension and other dimensions for controlling the next solution cycle's time-step size;
(e) calculating a fraction of corresponding nodal forces for said each node-pair to be redistributed for maintaining a stable solution and redistributing the fraction in accordance with a formula based on nodal masses and the speed-up scale factor;
(f) calculating the next solution cycle's time-step size using the critical dimension;
(g) incrementing the simulation time by the calculated time-step size; and
(h) repeating (b)-(g) until an end condition has reached.

2. The method of claim 1, wherein the group of candidate finite elements comprises thick-shell finite elements or solid finite elements in a single layer.

3. The method of claim 1, wherein the group of candidate finite elements comprises beam or truss finite elements.

4. The method of claim 1, wherein said each candidate finite element's smallest dimension is the substantially closer distance between the nodes of said each node-pair.

5. The method of claim 1, wherein the speed-up scale factor is greater than 1.

6. The method of claim 1, wherein the formula are as follows:
$$Δ F = ( \frac{{S}^{2}}{1 + {S}^{2}} ) ( \frac{{F}_{1} / {m}_{1} - {F}_{2} / {m}_{2}}{1 / {m}_{1} + 1 / {m}_{2}} )$$
$${F}_{1}^{final} = {F}_{1} - Δ F$$
$${F}_{2}^{final} = {F}_{2} + Δ F$$
where S is the speed-up scale factor, m₁ and m₂ are respective nodal masses of said each node-pair, F₁ and F₂ are the respective nodal forces of said each node-pair, ΔF is the calculated fraction of the corresponding nodal forces, and F₁^{final} and F₂^{final} are the respective nodal forces of said each node-pair after redistribution.

7. The method of claim 1, wherein the end condition comprises a user specified total simulation time.

8. A system for obtaining simulated structural behaviors of a product using explicit finite element analysis (FEA) with a time-step size control scheme, the system comprising:
an input/output (I/O) interface;
a memory for storing computer readable code for an explicit FEA application module;
at least one processor coupled to the memory, said at least one processor executing the computer readable code in the memory to cause the explicit FEA application module to perform operations of:
receiving a FEA model representing a product, the FEA model containing at least first and second layers of corresponding nodes to form a group of node-pairs, each node-pair containing one node in the first layer and a corresponding one in the second layer, the nodes in each node-pair being located in a substantially closer distance to each other comparing with distances to other nodes in the FEA model;
identifying a group of candidate finite elements for controlling time-step size, each of the candidate finite elements being defined by one or more of the node-pairs; and
obtaining simulated structural behaviors of the product by conducting a time-marching numerical simulation using the FEA model in a number of solution cycles as follows:
(a) setting a simulation time to zero;
(b) obtaining nodal forces of the FEA model including all of the candidate finite elements at the simulation time;
(c) calculating a scaled dimension by multiplying said each candidate finite element's smallest dimension by a speed-up scale factor;
(d) determining a critical dimension amongst the scaled dimension and other dimensions for controlling the next solution cycle's time-step size;
(e) calculating a fraction of corresponding nodal forces for said each node-pair to be redistributed for maintaining a stable solution and redistributing the fraction in accordance with a formula based on nodal masses and the speed-up scale factor;
(f) calculating the next solution cycle's time-step size using the critical dimension;
(g) incrementing the simulation time by the calculated time-step size; and
(h) repeating (b)-(g) until an end condition has reached.

9. The system of claim 8, wherein the group of candidate finite elements comprises thick-shell finite elements or solid finite elements in a single layer.

10. The system of claim 8, wherein the group of candidate finite elements comprises beam or truss finite elements.

11. The system of claim 8, wherein said each candidate finite element's smallest dimension is the substantially closer distance between the nodes of said each node-pair.

12. The system of claim 8, wherein the speed-up scale factor is greater than 1.

13. The system of claim 8, wherein the formula are as follows:
$$Δ F = ( \frac{{S}^{2}}{1 + {S}^{2}} ) ( \frac{{F}_{1} / {m}_{1} - {F}_{2} / {m}_{2}}{1 / {m}_{1} + 1 / {m}_{2}} )$$
$${F}_{1}^{final} = {F}_{1} - Δ F$$
$${F}_{2}^{final} = {F}_{2} + Δ F$$
where S is the speed-up scale factor, m₁ and m₂ are respective nodal masses of said each node-pair, F₁ and F₂ are the respective nodal forces of said each node-pair, ΔF is the calculated fraction of the corresponding nodal forces, and F₁^{final} and F₂^{final} are the respective nodal forces of said each node-pair after redistribution.

14. The system of claim 8, wherein the end condition comprises a user specified total simulation time.

15. A non-transitory computer readable storage medium containing computer instructions for obtaining simulated structural behaviors of a product using explicit finite element analysis (FEA) with a time-step size control scheme, the computer instructions when executed on a computer system having an explicit FEA application module installed thereon cause the computer system to perform operations of:
receiving, in a computer system having an explicit FEA application module installed thereon, a FEA model representing a product, the FEA model containing at least first and second layers of corresponding nodes to form a group of node-pairs, each node-pair containing one node in the first layer and a corresponding one in the second layer, the nodes in each node-pair being located in a substantially closer distance to each other comparing with distances to other nodes in the FEA model;
identifying, with the explicit FEA application module, a group of candidate finite elements for controlling time-step size, each of the candidate finite elements being defined by one or more of the node-pairs; and
obtaining, with the explicit FEA application module, simulated structural behaviors of the product by conducting a time-marching numerical simulation using the FEA model in a number of solution cycles as follows:
(a) setting a simulation time to zero;
(b) obtaining nodal forces of the FEA model including all of the candidate finite elements at the simulation time;
(c) calculating a scaled dimension by multiplying said each candidate finite element's smallest dimension by a speed-up scale factor;
(d) determining a critical dimension amongst the scaled dimension and other dimensions for controlling the next solution cycle's time-step size;
(e) calculating a fraction of corresponding nodal forces for said each node-pair to be redistributed for maintaining a stable solution and redistributing the fraction in accordance with a formula based on nodal masses and the speed-up scale factor;
(f) calculating the next solution cycle's time-step size using the critical dimension;
(g) incrementing the simulation time by the calculated time-step size; and
(h) repeating (b)-(g) until an end condition has reached.

16. The non-transitory computer readable storage medium of claim 15, wherein the group of candidate finite elements comprises thick-shell finite elements or solid finite elements in a single layer.

17. The non-transitory computer readable storage medium of claim 15, wherein the group of candidate finite elements comprises beam or truss finite elements.

18. The non-transitory computer readable storage medium of claim 15, wherein said each candidate finite element's smallest dimension is the substantially closer distance between the nodes of said each node-pair.

19. The non-transitory computer readable storage medium of claim 15, wherein the speed-up scale factor is greater than 1.

20. The non-transitory computer readable storage medium of claim 15, wherein the formula are as follows:
$$Δ F = ( \frac{{S}^{2}}{1 + {S}^{2}} ) ( \frac{{F}_{1} / {m}_{1} - {F}_{2} / {m}_{2}}{1 / {m}_{1} + 1 / {m}_{2}} )$$
$${F}_{1}^{final} = {F}_{1} - Δ F$$
$${F}_{2}^{final} = {F}_{2} + Δ F$$
where S is the speed-up scale factor, m₁ and m₂ are respective nodal masses of said each node-pair, F₁ and F₂ are the respective nodal forces of said each node-pair, ΔF is the calculated fraction of the corresponding nodal forces, and F₁^{final} and F₂^{final} are the respective nodal forces of said each node-pair after redistribution.
